(19) United States
(12) Patent Application Publication
(10) Pub. No.: US 2007/0285023 A1
(43) Pub. Date: Dec. 13, 2007

(54) Photovoltaic powered lighting

(76) Inventor: Sandra Robin Cooper, Milford, CT (US)

Correspondence Address: TAFT, STETTINIUS & HOLLISTER LLP, SUITE 1800, 425 WALNUT STREET, CINCINNATI, OH, 45202-3957, US

(21) Appl. No.: 11/726,390

(22) Filed: Mar. 21, 2007

Related U.S. Application Data
(60) Provisional application No. 60/791,539, filed on Apr. 12, 2006.

(51) Int. Cl. H05B 37/02; F21L 4/00

(52) U.S. Cl. 315/149; 362/183

(57) ABSTRACT

A lighting device comprising a housing having at least one side defining an internal cavity, the internal cavity occupied by a photovoltaic cell and a stored energy source in electrical communication with the photovoltaic cell, the internal cavity further occupied by a visible light source and an electrical switch, wherein the at least one side of the housing further includes at least one illumination panel, wherein each illumination panel includes a translucent pane in series with an opaque pane to define a visual image, wherein the visible light source is in communication with the electrical switch and in selective electrical communication with the stored energy source to illuminate the visual image at a predetermined time, wherein the translucent pane includes a mottled layer, and wherein the photovoltaic cell is covered by at least one illumination panel.

### CROSS REFERENCE TO RELATED APPLICATIONS

The present application claims the benefit of U.S. Provisional Patent Application Ser. No. 60/791,539, filed Apr. 12, 2006, the disclosure of which is hereby incorporated by reference.

### FIELD OF THE INVENTION

The present invention is directed to photovoltaic powered lighting and, more specifically, to portable photovoltaic powered lighting having a power generation source, a power storage device, and an illumination source all contained within an enclosed housing.

### INTRODUCTION TO THE INVENTION

The instant invention encompasses decorative lighting that provides soft, widely dispersed illumination in a self-contained housing. In exemplary form, a self-contained housing includes internal photovoltaic cells operative to convert radiation into electric current, where the electric current is stored as chemical energy in batteries, where the energy is eventually converted back to electric current and utilized to power an illumination source. Each of the foregoing aspects of the exemplary embodiment described are contained within the housing. As a result, the decorative lighting is completely independent of household electricity or other external power source, thereby enabling the lighting to be portable and repositioned in any desired location with ease and simplicity.

In accordance with the present invention, a housing, optionally formed from metal, comprises a frame structure that may be fabricated into any desired size and shape. The frame structure incorporates one or more visible panels that comprise a translucent layer and an opaque layer cooperative to define a visual image. In exemplary form, the visible panels may be a unitary panel or comprise laminated or stacked panels constructed to possess a light defusing quality, commonly referred to in the instant disclosure as translucent. For purposes of the present disclosure, translucent means allowing light to pass through a material, but the material does not allow objects to be seen clearly through it. Exemplary visual images include, but are not limited to, ornamental patterns, tribal symbols, and random designs. In an alternate embodiment of the invention, the visible panels are removable from the housing and fabricated from polymer materials. In fabricating the visible panels, various materials may be utilized such as, without limitation, polyvinyl chloride, stabilizers and/or plasticizers.

A self-contained illumination source such as a light bulb or light emitting diode (LED) is mounted in the frame structure along with a photovoltaic power source. In this way, ambient radiation passing through the visible panels is absorbed and stored as chemical energy. After the ambient light reaches a predetermined, lower intensity level, the illumination source is automatically powered from the stored energy source to illuminate the visual image.

It is a first aspect of the present invention to provide a lighting device comprising a housing having at least one side defining an internal cavity, the internal cavity occupied by a photovoltaic cell and a stored energy source in electrical communication with the photovoltaic cell, the internal cavity further occupied by a visible light source and an electrical switch, where the at least one side of the housing further includes at least one illumination panel, where each illumination panel includes a translucent pane in series with an opaque pane to define a visual image, where the visible light source is in communication with the electrical switch and selective electrical communication with the stored energy source to illuminate the visual image at a predetermined time, where the translucent pane includes a mottled layer, and where the photovoltaic cell is covered by at least one illumination panel.

In a more detailed embodiment of the first aspect, the housing includes four sides angled ninety degrees with respect to one another to provide a rectangular cross-section, the housing includes a top side and a bottom side opposing the top, the four sides cooperate with the top side and bottom side to define the internal cavity, and at least three of the four sides include a separate illumination panel. In yet another more detailed embodiment, the electrical switch is in electrical communication with an ambient light detector, and the predetermined time during which the visual image is illuminated depends upon an intensity of ambient light detected by the ambient light detector.

In yet another more detailed embodiment of the first aspect, the electrical switch is in electrical communication with an ambient light detector, the electrical switch is in electrical communication with a rheostat being operative to vary an intensity of the illumination source, the predetermined time during which the visual image is illuminated depends upon an intensity of ambient light detected by the ambient light detector, and the intensity of the illumination source depends upon the intensity of ambient light detected by the ambient light detector, where less ambient light detected by the ambient light detector results in greater intensity of the illumination source. In still another more detailed embodiment, the housing is readily portable. In a further detailed embodiment, the housing includes a cylindrical receiver, the lighting device includes a self-contained light assembly within a cylindrical housing, the light assembly including the photovoltaic cell, the stored energy source, the visible light source, and the electrical switch, and the light assembly is received within the cylindrical receiver to mount the light assembly to the housing.

It is a second aspect of the present invention to provide a lighting device comprising a housing having an internal cavity that is occupied by a photovoltaic cell and a stored energy source in electrical communication with the photovoltaic cell, the internal cavity further occupied by a visible light source and an electrical switch, where the housing further includes at least one arcuate illumination panel, where each arcuate illumination panel includes a translucent pane in series with an opaque pane to define a visual image, where the visible light source is in communication with the electrical switch and selective electrical communication with the stored energy source to illuminate the visual image at a predetermined time, where the translucent pane includes a mottled layer, and where the photovoltaic cell is covered by at least one panel.

In a more detailed embodiment of the second aspect, the housing includes four sides angled ninety degrees with respect to one another to provide a rectangular cross-section, the housing includes a top side and a bottom side opposing the top, the four sides cooperate with the top side and bottom side to define the internal cavity, and at least three of the four sides include a separate illumination panel. In yet another more detailed embodiment, the electrical switch is in electrical communication with an ambient light detector, and the predetermined time during which the visual image is illuminated depends upon an intensity of ambient light detected by the ambient light detector.

In yet another more detailed embodiment of the second aspect, the electrical switch is in electrical communication with an ambient light detector, the electrical switch is in electrical communication with a rheostat being operative to vary an intensity of the illumination source, the predetermined time during which the visual image is illuminated depends upon an intensity of ambient light detected by the ambient light detector, and the intensity of the illumination source depends upon the intensity of ambient light detected by the ambient light detector, where less ambient light detected by the ambient light detector results in greater intensity of the illumination source. In still another more detailed embodiment, the housing is readily portable. In a further detailed embodiment, In still a further detailed embodiment, the visual image comprises a plurality of ornamental designs.

It is a third aspect of the present invention to provide a method of illuminating an ornamental object, the method comprising: (a) producing electrical energy using a photovoltaic cell by exposing the photovoltaic cell to a radiant energy source emitting radiant energy, where the radiant energy passes through a translucent pane before reaching the photovoltaic cell, where the translucent pane includes a mottled layer; (b) converting the electrical energy into chemical energy; (c) subsequently converting the chemical energy into electrical current operative to power an illumination source; and (d) illuminating an ornamental image using the electrical current to power the illumination source rendering viewable the illuminated ornamental image from greater than 180 degrees, where the illumination source is housed within a portable housing, where the ornamental image comprises the translucent pane in series with an opaque layer to define a visual image, and where the foregoing acts are carried out within the housing.

### BRIEF DESCRIPTION OF THE DRAWINGS

FIG. 1 is a frontal view of a first exemplary embodiment of the instant invention;

FIG. 2 is a left-side view of the exemplary embodiment of FIG. 1;

FIG. 3 is an overhead view of the exemplary embodiment of FIG. 1;

FIG. 4 is a bottom view of the exemplary embodiment of FIG. 1;

FIG. 5 is an elevated perspective view of the exemplary embodiment of FIG. 1, with the door open;

FIG. 6 is a profile view of a second exemplary embodiment of the instant invention;

FIG. 7 is an overhead view of the exemplary embodiment of FIG. 6;

FIG. 8 is a bottom view of the exemplary embodiment of FIG. 6;

FIG. 9 is an exploded view of the exemplary embodiment of FIG. 6;

FIG. 10 is a bottom view of an exemplary self-contained lighting structure in accordance with the instant invention; and

FIG. 11 is an elevated perspective view of the exemplary self-contained lighting structure of FIG. 10.

### DETAILED DESCRIPTION OF EXEMPLARY EMBODIMENTS

The exemplary embodiments of the present invention are described and illustrated below to encompass methods of illuminating ornamental objects and the resulting illuminated ornamental objects themselves. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

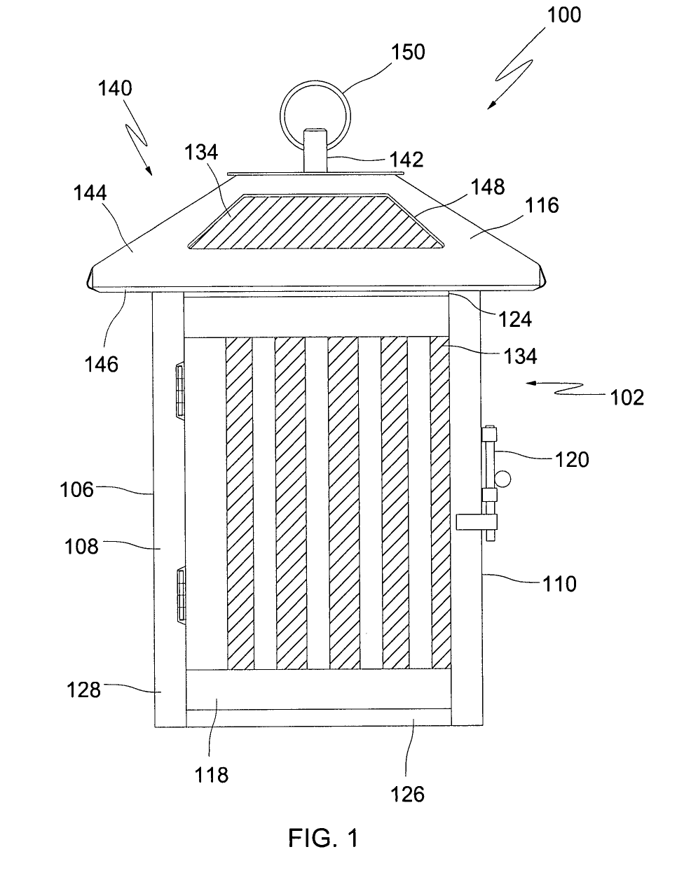

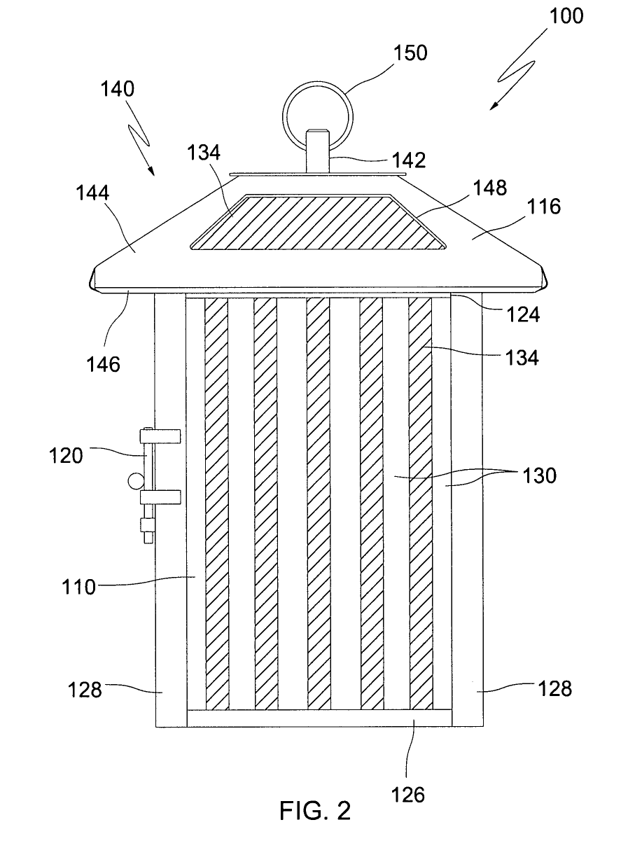

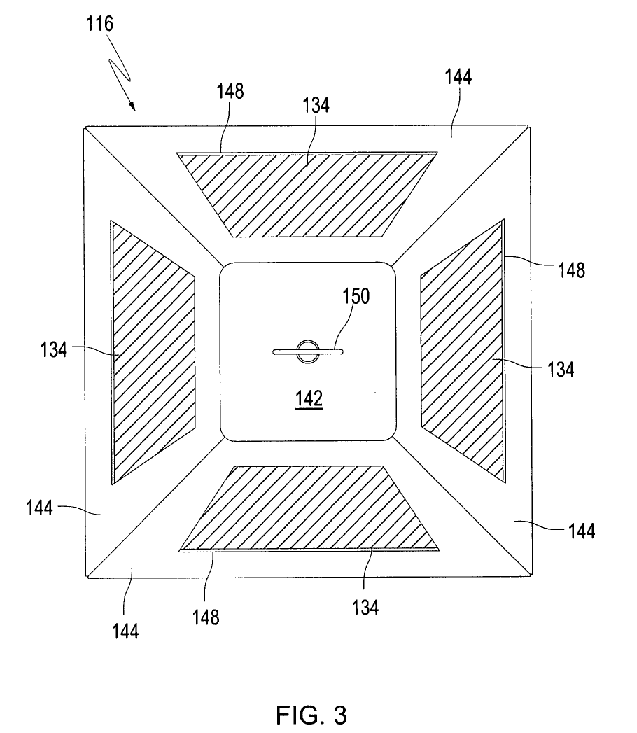

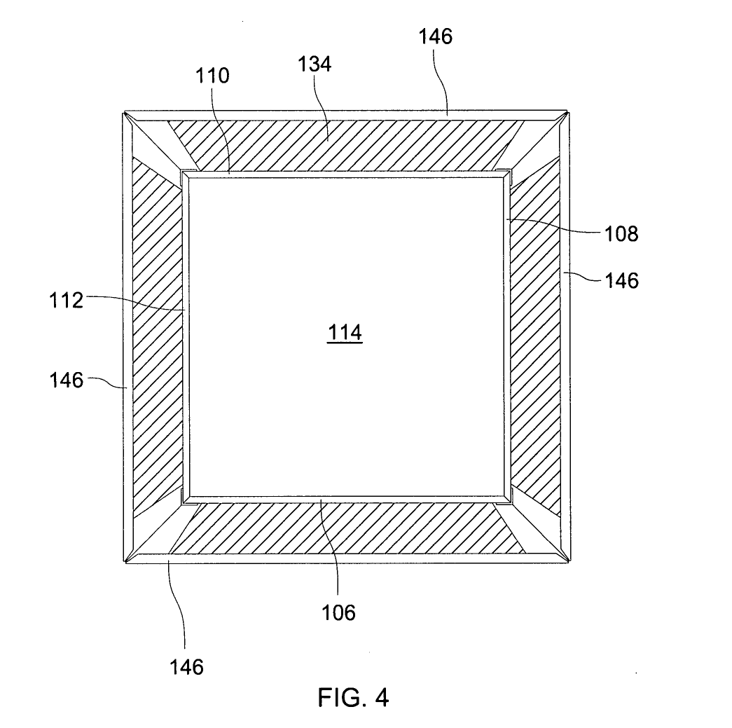

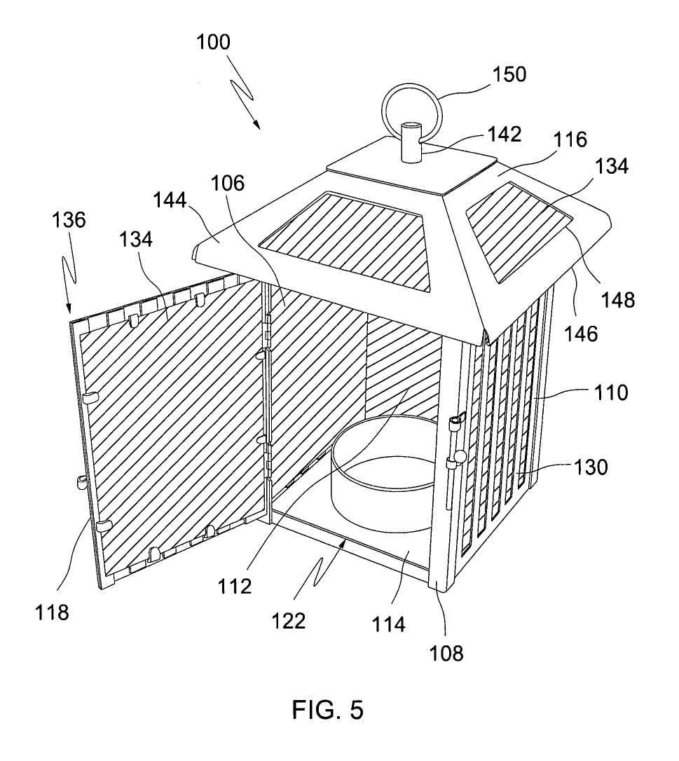

Referencing FIGS. 1-5, an exemplary lantern 100 includes a housing 102 and a self-contained illumination source 104. The housing 102 includes a four vertical walls 106, 108, 110, 112, a floor 114, and a lid 116 mounted to one another to enclose an internal volume. All four walls 106, 108, 110, 112 are mounted to one another at right angles to define a generally rectangular cross-section along the horizontal plane. One of the walls 108 includes a repositionable door 118 having a latch 120 allowing the door to be latched shut or optionally unlatched to allow access to the internal volume of the lantern 100. The lid 116 is mounted to the top of the walls 106, 108, 110, 112, while the floor 114 is mounted to the bottom of the walls.

In exemplary form, the walls 106, 108, 110, 112 are comprised of sheet metal strips that are welded to one another to form a rectangular frame 122. Each rectangular frame includes a header 124, an angle bar footer 126, and two angle bar vertical end members 128. Three of the four walls 106, 110, 112 include a series of metal strips 130 vertically oriented and mounted to the header and footer between the end members, thereby providing gaps between adjacent strips. Adjacent frames 122 of each wall are mounted to one another by welding an angle bar member 128 over adjacent headers 124 and footers 126. An illumination panel 134 is mounted to the interior of each wall 106, 110, 112 and over the metal sheet strips to cover the gaps between adjacent metal strips 130. The fourth wall 108 includes a rectangular frame 122, but the metal strips 130 are mounted to a second, smaller rectangular frame 136 that comprises the repositionable door. An illumination panel 134 is mounted to the inside of the door and covers each of the gaps between adjacent metal strips 130. Thus, when the door is in the closed position, light entering the interior cavity of the lantern 100 through the walls 106, 108, 110, 112 almost exclusively enters through the illumination panels 134.

The lid 116 comprises a four sided frustapyrimidal roof structure 140 with a mounting bracket 142 to mount the lantern 100 as a hanging structure. The roof structure 140 includes four trapezoidal panels 144, with one side of each panel being overlapped by an adjacent panel, while the opposite side of the same panel is overlapped by another adjacent panel. A square opening (not shown) defined collectively at the tops of the panels 144 is covered by the mounting bracket 142, which includes a square platform mounted to the tops of the panels 144. Adjacent panels 144 are welded to one another, with the ends 146 being formed to be substantially perpendicular to the floor 114 to provide an overhang. Each of the panels 144 includes a trapezoidal opening 148 that is closed off by mounting an illumination panel 134 to the inside surface of the panel 144. Thus, light entering the interior cavity of the lantern 100 through the lid almost exclusively enters through the illumination panels.

The floor 114 comprises a rectangle of sheet metal mounted to the bottoms of the footers 126 of the walls 106, 108, 110, 112. A metal ring 150 is welded to a circular platform 152 to define a cylindrical cavity, generally centered, to accept and house the self-contained light assembly 104, where the ring and platform are mounted to the floor 114. In this manner, light entering the interior cavity of the lantern 100 almost exclusively enters through the illumination panels of the walls 106, 108, 110, 112 and lid 116.

In exemplary form, each illumination panel 134 comprises a relatively thin plastic material which is translucent. Exemplary materials for constructing the illumination panel include, without limitation, polyvinyl chloride treated with a stabilizer and/or a plasticizer to provide a frosted appearance and mottled topography. Exemplary stabilizers and/or plasticizers include, without limitation, tetrahydrofuran and a chlorinated solvent. However, any alternate production method or materials can be employed without departing from the scope of the invention, so long as the panel 134 includes the desired foggy translucent visual appearance. When incorporating the panels 134 into the instant invention, the self-contained illumination source 104 is operative to produce light, a portion of which is absorbed by the panels 134 to produce a soft, warm glow with any color employed for the lamp or LED appearing with generally the same intensity throughout the entire surface of panel 134.

It is also within the scope of the invention to fabricate illumination panels 134 from materials other than plastic, such as, without limitation, glass. When transparent glass is used as the illumination panel, an etchant may be applied to an exposed surface of the glass to provide a frosted appearance. Likewise, translucent glass may include materials such as titanium dioxide to provide a frosted appearance.

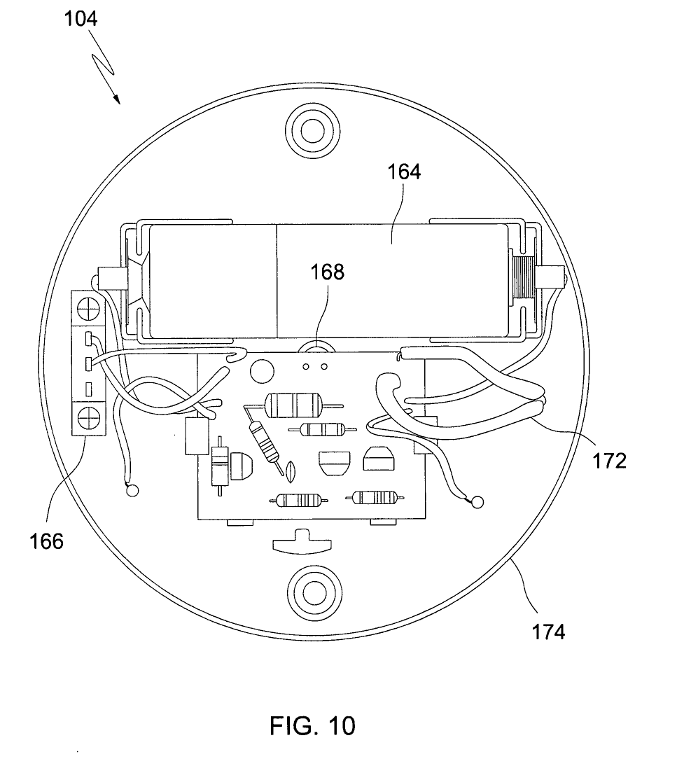

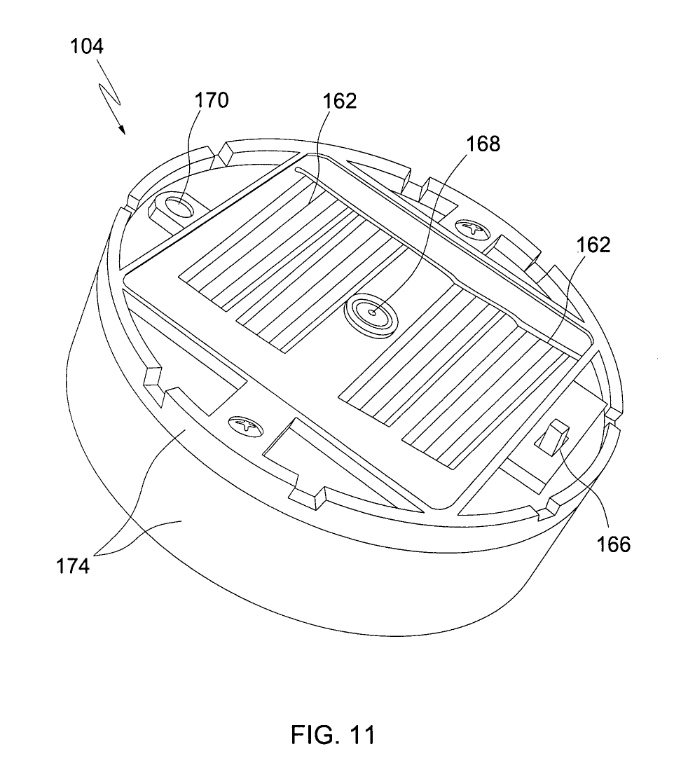

Referencing FIGS. 10 and 11, the self-contained light assembly 104 includes a photovoltaic cell 162, a stored energy source 164, an electrical switch 166, a light source 168, an ambient light detector 170, associated circuitry 172 interconnecting the elements, and a cylindrical housing 174 enclosing the majority of the elements. In exemplary form, the stored energy source is a commercially available rechargeable battery or battery pack comprising, such as, without limitation, nickel metal hydride (NiMH), lithium ion (Li-ion), or nickel cadmium (Ni-Cad). Exemplary battery sizes for use within the instant invention encompasses all those known to one skilled in the art of batteries. In exemplary form, this includes a single AAA battery.

Illumination of the lantern 100 is provided indirectly by solar radiation. The photovoltaic cell 162, exposed through the top of the housing 174, is operative to generate an electron stream, in response to its exposure to the solar radiation, that is directed to the stored energy source 164 to charge the source. The stored energy source 164 utilizes the electron stream to carry out a chemical reaction and thus transforms the electronic potential of the electron stream into chemical potential using a reversible chemical reaction. When the ambient light detector 170, also exposed through the top of the housing 174, produces a signal indicative of a light intensity falling below a predetermined ambient light intensity and the switch is already moved to the “ON” position, the stored energy source 164 is in electrical communication with the light source 168. This connection converts the chemical potential of the stored energy source into electrical potential to power the light source and generate visible light. It is presumed that the solar radiation received on a daily basis is operative to power the light source during the corresponding evening hours. What is particularly worth noting is that the solar radiation is received by the photovoltaic cell 162 after passing though the illumination panels 134. The visible light generated by the visible light source 168 is operative to illuminate the illumination panels 134 and produce a uniform, soft lighting to generate a visible image defined by the opaque housing 12 and the illumination panels 134. The foregoing process is repeated as the ambient light detector 170 produces a signal indicative of a light intensity at or above a predetermined ambient light intensity so that energy from the photovoltaic cell 162 is directed to the stored energy source 164, and the stored energy source is no longer in electrical communication with the light source 168.

In exemplary form, the light source 168 comprises one or more light emitting diodes (LEDs). However, the instant invention is not limited to LEDs and may alternatively or in addition utilized one or more other lighting devices, such as, without limitation, conventional light bulbs with energized filaments or energized gaseous species. Those skilled in the art will readily understand that the light emitting source chosen may have an impact on choosing photovoltaic cells 162 and a stored energy source 164 commensurate with the load of the light source 168.

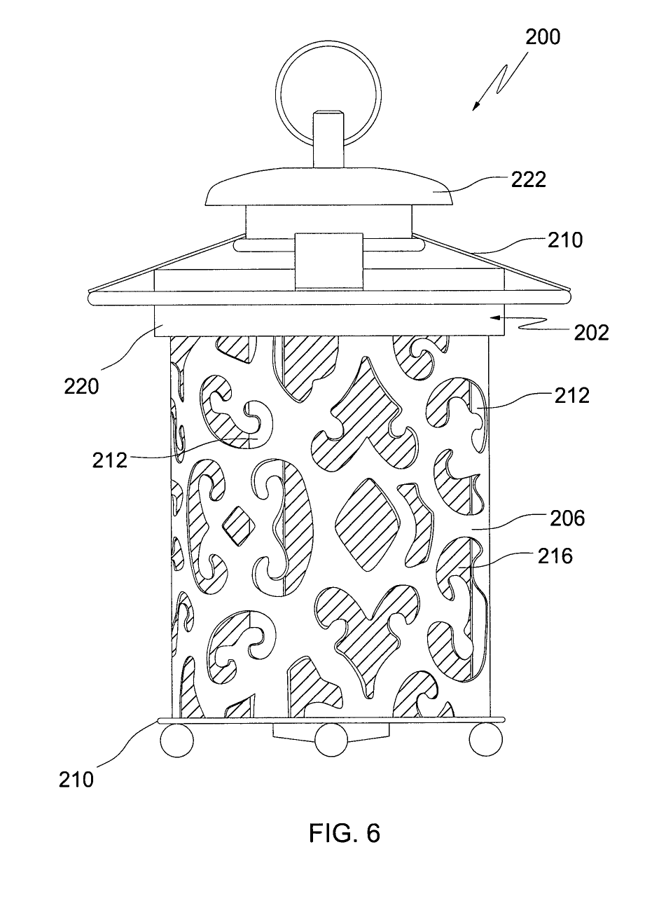

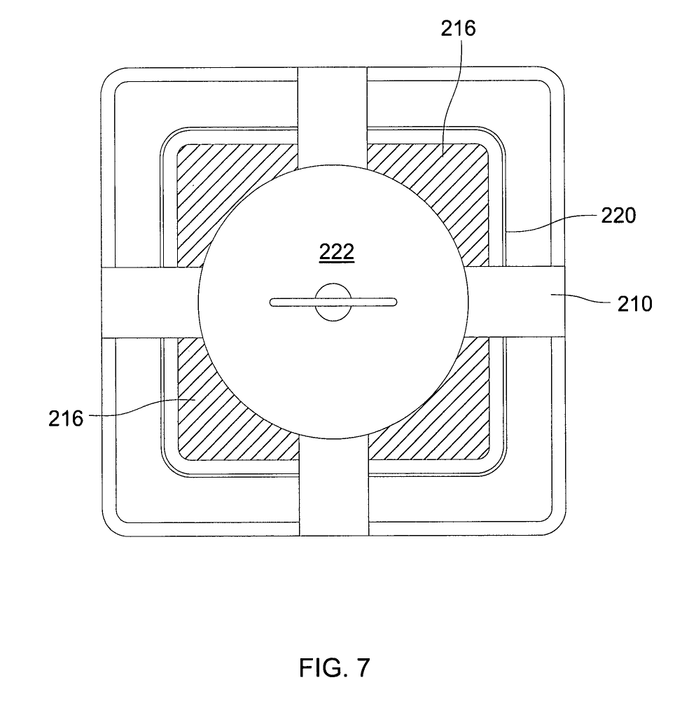

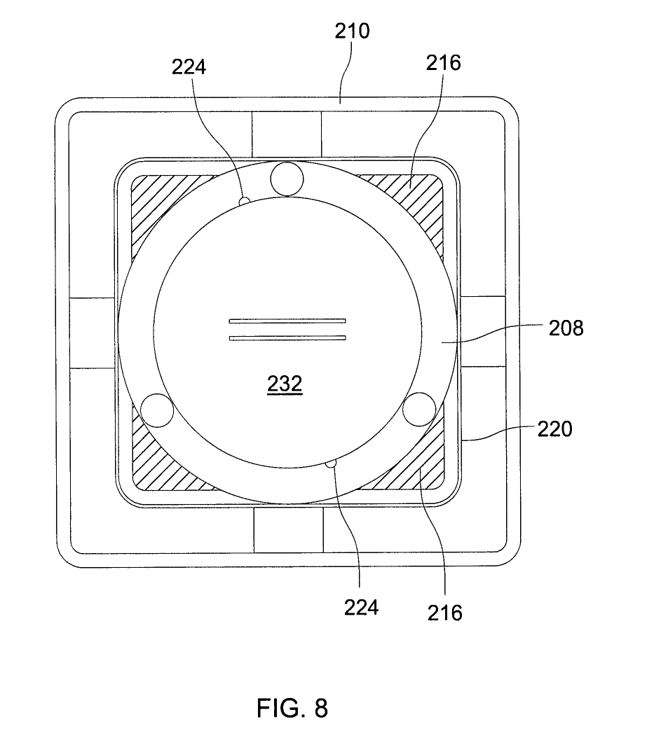

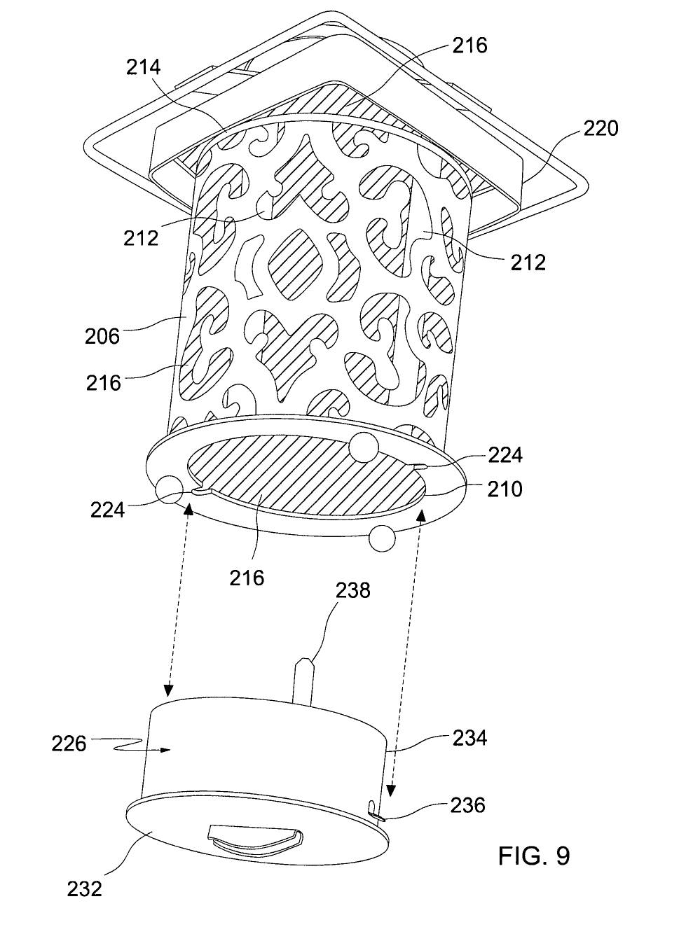

Referencing FIG. 6-9, a second exemplary lantern 200 includes a housing 202 and a self-contained illumination source 204. The self-contained illumination source 204 is the same as that discussed for the first exemplary embodiment 104 and will not be repeated for purposes of brevity. In this exemplary lantern 200, the housing 202 includes a circular or arcuate wall 206, a floor 208, and a lid 210 mounted to one another to enclose an internal volume. The floor 208 includes a circular opening 210 selectively allowing access to the internal volume.

In exemplary form, the circular wall 206 is comprised of a single metallic sheet stamped out to define ornamental features. The sheet is then circumferentially wound around and welded to five vertical posts 212 spaced apart from one another to form the wall 206. Each vertical post 212 is welded to the floor 208 and to a top ring 214, thereby defining a generally tubular body. Inset within the tubular body is a tubular illumination panel 216. This means that light traveling beyond the wall 206 and posts 212 and into the interior of the lantern 200 is almost exclusively passing through the illumination panel 216.

In exemplary form, the lid 208 comprises a generally square frame 220 having an ornamental cap 222 for mounting the lantern 200 in a hanging position. The opening defined by the frame 220 is enclosed by another illumination panel 216. Thus, light traveling beyond the lid 208 and into the interior of the lantern 200 is almost exclusively passing through the illumination panel 216.

In exemplary form, the floor 208 includes a generally circular piece of sheet metal having a circular opening 210 with two cut-outs 224. An illumination housing 226 is adapted to be selectively received through the opening 210 and into the internal volume of the lantern 200. The illumination housing 226 includes a generally circular piece of sheet metal 232 having a diameter greater than the diameter of the circular opening 210. A metallic ring 234 is mounted to the circular sheet 232 to provide a cylindrical receiver for the self-contained illumination source 204. The metallic ring 234 also includes two projections 236 operative to align with the two cut-outs 224 through the floor 208 to allow insertion of the housing 226 through the opening 210 and thereafter provide retention of the housing by turning the housing so that the projections 236 are caught on a circumferential ledge of the floor 208 defining the opening 210. As discussed briefly beforehand, the self-contained illumination source 204 is the same as that discussed for the first exemplary embodiment 104 and is simply inserted into the housing 226 and retained thereby as a result of a friction fit. It is also within the scope of the invention for the ring 234 to include bendable clips 238 that would also operate to retain the illumination source 204 within the illumination housing 226.

In each of the foregoing exemplary lanterns 100, 200, the structures may comprise any desired decorative elements, such as, without limitation, leaves and flowers. The principals of illumination panels and a self-contained illumination source can likewise be applied to freestanding structures fabricated to resemble lamps, as well as freestanding structures resembling animal sculptures.

As used herein, the term “panel” encompasses flat sheets, arcuately shaped sheets, and three-dimensional objects such as bulbs and pyramids that enable the absorbed light in one portion of the material to be transmitted throughout the material causing all or substantially all of the material comprising the panel to illuminate.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A lighting device comprising:
a housing having at least one side defining an internal cavity, the internal cavity occupied by a photovoltaic cell and a stored energy source in electrical communication with the photovoltaic cell, the internal cavity further occupied by a visible light source and an electrical switch, wherein the at least one side of the housing further includes at least one illumination panel, wherein each illumination panel includes a translucent pane in series with an opaque pane to define a visual image, wherein the visible light source is in communication with the electrical switch and in selective electrical communication with the stored energy source to illuminate the visual image at a predetermined time, wherein the translucent pane includes a mottled layer, and wherein the photovoltaic cell is covered by at least one illumination panel.

2. The lighting device of claim 1, wherein:
the housing includes four sides angled ninety degrees with respect to one another to provide a rectangular cross-section;
the housing includes a top side and a bottom side opposing the top;
the four sides cooperate with the top side and bottom side to define the internal cavity; and
at least three of the four sides include a separate illumination panel.

3. The lighting device of claim 1, wherein:
the electrical switch is in electrical communication with an ambient light detector; and
the predetermined time during which the visual image is controlled by the ambient light detector.

4. The lighting device of claim 3, wherein:
the electrical switch is in electrical communication with an ambient light detector;
the electrical switch is in electrical communication with a rheostat being operative to vary an intensity of the illumination source;
the predetermined time during which the visual image is illuminated depends upon an intensity of ambient light detected by the ambient light detector; and
the intensity of the illumination source depends upon the intensity of ambient light detected by the ambient light detector, where less ambient light detected by the ambient light detector results in greater intensity of the illumination source.

5. The lighting device of claim 1, wherein the housing is readily portable.

6. The lighting device of claim 1, wherein the visual image comprises a plurality of ornamental designs.

7. The lighting device of claim 1, wherein
the housing includes a cylindrical receiver;
the lighting device includes a self-contained light assembly within a cylindrical housing, the light assembly including the photovoltaic cell, the stored energy source, the visible light source, and the electrical switch; and
the light assembly is received within the cylindrical receiver to mount the light assembly to the housing.

8. The lighting device of claim 7, wherein the self-contained light assembly includes an ambient light detector in electrical communication with the electrical switch.

9. A lighting device comprising:
a housing having an internal cavity that includes a photovoltaic cell and a stored energy source in electrical communication with the photovoltaic cell, the internal cavity further including a visible light source and an electrical switch, wherein the housing further includes at least one arcuate illumination panel, wherein each arcuate illumination panel includes a translucent pane in series with an opaque pane to define a visual image, wherein the visible light source is in communication with the electrical switch and selective electrical communication with the stored energy source to illuminate the visual image at a predetermined time, wherein the translucent pane includes a mottled layer, and wherein the photovoltaic cell is covered by at least one illumination panel.

10. The lighting device of claim 9, wherein:
the housing includes a circular cross-section;
the at least one arcuate illumination panel circumscribes the internal cavity; and
the illuminated image is viewable from approximately 360 degrees.

11. The lighting device of claim 9, wherein:
the electrical switch is in electrical communication with an ambient light detector; and
the predetermined time during which the visual image is controlled by the ambient light detector.

12. The lighting device of claim 11, wherein:
the electrical switch is in electrical communication with an ambient light detector;
the electrical switch is in electrical communication with a rheostat being operative to vary an intensity of the illumination source;
the predetermined time during which the visual image is illuminated depends upon an intensity of ambient light detected by the ambient light detector; and
the intensity of the illumination source depends upon the intensity of ambient light detected by the ambient light detector, where less ambient light detected by the ambient light detector results in greater intensity of the illumination source.

13. The lighting device of claim 9, wherein the housing is readily portable.

14. The lighting device of claim 9, wherein the visual image comprises a plurality of ornamental designs.

15. The lighting device of claim 9, wherein
the housing includes a cylindrical receiver;
the lighting device includes a self-contained light assembly within a cylindrical housing, the light assembly including the photovoltaic cell, the stored energy source, the visible light source, and the electrical switch; and
the light assembly is received within the cylindrical receiver to mount the light assembly to the housing.

16. The lighting device of claim 15, wherein the self-contained light assembly includes an ambient light detector in electrical communication with the electrical switch.

17. A method of illuminating an ornamental object, the method comprising:
producing electrical energy using a photovoltaic cell by exposing the photovoltaic cell to a radiant energy source emitting radiant energy, where the radiant energy passes through a translucent pane before reaching the photovoltaic cell, where the translucent pane includes a mottled layer;
converting the electrical energy into chemical energy;
subsequently converting the chemical energy into electrical current operative to power an illumination source; and
illuminating an ornamental image using the electrical current to power the illumination source rendering viewable the illuminated ornamental image from greater than 180 degrees, where the illumination source is housed within a portable housing;
wherein the ornamental image comprises the translucent pane in series with an opaque layer to define a visual image; and
wherein the foregoing acts are carried out within the housing.
